(19) United States
(12) Patent Application Publication
(10) Pub. No.: US 2011/0252172 A1
(43) Pub. Date: Oct. 13, 2011

(54) SYSTEM AND METHOD FOR CONCURRENT OPERATION OF DUAL INTERFACES BETWEEN UICC AND MOBILE DEVICE

(76) Inventors: Jun Sun, Fremont, CA (US); Yuji Wei, San Jose, CA (US)

(21) Appl. No.: 12/757,955

(22) Filed: Apr. 9, 2010

(51) Int. Cl. G06F 13/14; G06K 19/07

(52) U.S. Cl. 710/305; 235/492

(57) ABSTRACT

This invention relates to a process and system for operating a UICC with a terminal such as a cell phones or a PC, where there is an ISO 7816 channel and/or an IC-USB channel between the UICC and the terminal. The invention enables a Concurrent operation mode for simultaneously communicating data or ISO protocol commands over the ISO 7816 channel and communicating data or USB protocols over the IC-USB channel. The system dynamically enters and exits Concurrent mode when both the UICC and the terminal support it, and operates in standard operation modes when either of them does not support it. In one embodiment, on the terminal, the ISO interface is connected to the communication processor and the IC-USB interface is connected to the application processor through a USB bridge chip, and the UICC can be configured either as a host or a gadget.

### FIELD OF THE INVENTION

The present invention relates to systems with a terminal and a Universal Integrated Circuit Card (UICC), and the concurrent operation of dual interfaces between the terminal and the UICC.

### BACKGROUND OF THE INVENTION

Smart cards (SC) are widely used today in applications such as healthcare, public phone, parking, loyalty programs, cash payments, credit payments and portable data storage. The SC is essentially a small form-factor card with embedded integrated circuit, which may include a memory for storing data and instructions, and a microprocessor for executing the instructions. The SC functions in conjunction with a SC reader which is attached to a computing or communication device, such as a personal computer, a cell phone, or a point of sale terminal (henceforth all referred to as terminal). The SC communicates with the SC reader using a serial protocol. The specification of the protocol was originally published by the International Standard Organization (ISO) in the ISO 7816-3 standard. The SC reader communicates with the terminal through a serial port, a parallel port, a universal serial bus (USB), or other means, using a separate protocol.

In mobile device domain, a UICC is a special SC that holds personal data and keys to access the mobile network and maintains their secrecy and integrity. The UICC is used in mobile terminals in Global System for Mobile Communications (GSM) and Universal Mobile Telecommunications System (UMTS) third-generation (3G) mobile telecommunications technologies, which is also being developed into a 4G technology. Mobile terminals have built-in UICC readers. There are also standalone UICC readers that can be connected to PCs or other terminals. TS 102 221, a standard from the European Telecommunications Standards Institute (ETSI), defines the interface between the UICC and the terminal. It specifies the requirements for the physical characteristics of the UICC; the electrical interface for exchanging Application Protocol Data Units (APDUs) between the UICC and the terminal, based on ISO 7816-3; the initial communication establishment and the transport protocols for this interface; a model which serves as a basis for the logical structure of the UICC APDU interface; the communication commands and procedures for the UICC APDU interface; and the application independent files and protocols for the UICC APDU interface.

In recent years, there are increasing demands on using UICC to store large quantity of data, to host web server, and to host streaming server. It is thus necessary to provide an interface between a UICC and a UICC reader that facilitates higher bandwidth transfer of data than what is offered by the ETSI TS 102 221 standard. Because of this, ETSI TS 102 600 was drafted and approved to provide a USB based interface for UICC. The specification standardizes the characteristics of the USB electrical interface between a USB-enabled UICC and a USB-enabled UICC reader, the initial communication establishment and the transport protocols, and the communication layers between the UICC and the UICC reader.

The ETSI TS 102 600 standards define two operation modes: the original ISO 7816 mode, and the new Inter-Chip USB (IC-USB) mode. TS 102 600 standardizes IC-USB as the official high speed interface for connections between the phone's main chipset and the SIM, or UICC, card. Here a chipset is commonly used to refer to a set of specialized chips on a computer's motherboard, peripheral card or an expansion card. In the IC-USB operation mode, APDUs in compliance with ISO 7816 are transmitted over ICCD (Integrated Circuit Card Device) class through the USB bus. In addition to ICCD function, ETSI TS 102 600 also includes CDC/EEM (Communication Device Class/Ethernet Emulation mode) for TCP/IP based networking communication services and UMS (USB mass storage) for data storage.

ETSI TS 102 600 explicitly mandates that the two modes of operation, the ISO mode and the IC-USB mode, are mutually exclusive. After the initial communication establishment state, the system either goes to the ISO mode or the IC-USB mode. Once in the ISO mode, the system can transition to IC-USB mode through a special Protocol and Parameter Selection (PPS) command from the UICC reader to the UICC. Once the system is in the IC-USB mode, it can not transition back to the ISO mode without restarting the system (by detaching and reattaching the UICC with the UICC reader, or by powering off the system).

Several potential issues may arise when implementing a UICC system conforming to the ESTI TS 102 600 standard. The ESTI TS 102 600 standard dictates that when the terminal is in the IC-USB mode, the ISO 7816 interface is deactivated, and that the ISO 7816 protocol data is transmitted through the USB interface along with other protocol data. This poses implementation challenges to terminals that have separate communication and application processors (such as most smart phones).

This is because the USB interface needs to be connected to one of the two processors. However, if it is connected to the application processor, then all APDU commands previously handled by the communication processor will need to go through the application processor. This conflicts with the current architecture of mobile handsets and would require extensive changes in both side as well as the interface changes between application processor and communication processor.

Conversely, if the USB interface is connected with the communicator processor, then communication processor needs to handle all other non-APDU related USB protocols, such as USB mass storage and Ethernet Emulation Mode and export these functionalities to application processor. This incurs high implementation cost to communication processor and again introduces interface changes between application processor and communication processor. Today, application processor and communication processor are two different segments of the industry, and thus making this cross-segment interface change requires extraordinary amount of effort.

While demands for IC-USB based advanced services mentioned above are already here today, there is no IC-USB chipset available on the market today. Because of the above mentioned difficulty, such IC-USB chipset may not be available on the market for a while.

What is needed is a system and an associated process that overcomes the above described problems and makes it easy and cost-efficient to support services targeted by IC-USB, and meanwhile can still inter-operate with ETSI TS 102 600 compliant UICC or mobile terminal that may emerge in the future.

### SUMMARY OF THE INVENTION

This invention relates to 1) a new operation mode, called Concurrent mode that supports two interfaces between the terminal and the UICC to be used at the same time. One of the interfaces is the legacy ISO interface that supports SIM applications, and the other interface is the IC-USB interface that supports higher speed data transfer; 2) two new capability profiles for both terminals and UICCs as a result of this new Concurrent operation mode. A capability profile here refers to the set of operational modes a terminal or a UICC supports, plus the logic for transitioning among these operation modes during run-time. The two new profiles supported by this invention include one that includes ISO and Concurrent modes of operation, and the other that includes ISO, IC-USB, and Concurrent modes of operation; 3) process for making terminals and UICCs having one of the two new capability profiles compatible with those with standard capabilities profiles; and 4) a low cost implementation of the Concurrent mode where a UICC card is connected through the ISO 7816 interface to the communication processor of the terminal and connected through the IC-USB interface to the application processor of the terminal with a USB bridge chip, and where the UICC can be configured as either a USB host or a USB gadget.

In more detailed description, this invention relates to a computer process operated within the framework of control of software (software broadly defined as source code or object code stored in any medium such as firmware or volatile and non volatile memory) embodied in a computer readable medium including: code for supporting a first profiles on a smart card device, code for supporting a second profile on a terminal, code for supporting each of the one or more of the operation modes of each of the one or more of the profiles, code for transitioning among one or more of the operation states of each of the one or more profiles, and code for determining a runtime profile when the smart card device is connected to the terminal using one or more interfaces.

In addition to the ISO and IC-USB operation modes as defined by the ETSI TS 102 600 standard, the invention herein discloses a novel Concurrent mode operation, where both the ISO and the IC-USB interfaces can be active and operational at the same time. The invention herein also discloses two new operation profiles associated with Concurrent mode and associated transitioning process. The system can enter and exit Concurrent mode operation from and to ISO mode operation, respectively. The transitioning is controlled by a mobile terminal through run-time commands sent over an ISO interface. In one embodiment, such commands take the form of newly extended APDU commands.

This invention also more specifically relates to a computer system including: a smart card connected to a terminal through one or more interfaces, a computer memory within the smart card for storing a first profile for supporting one or more operational modes, a computer memory within the terminal for storing a second profile for supporting one or more operational modes, wherein said first profile and said second profile associatively determine the system's runtime profile for supporting one or more operational modes, and the system dynamically transitions among operational modes supported by the runtime profile.

One embodiment of the invention is a system including a UICC and a terminal, and is used for one of the following runtime profiles: ISO mode only (Profile A), ISO mode plus IC-USB mode (Profile B), ISO mode plus Concurrent mode (Profile C), and ISO mode plus IC-USB mode plus Concurrent mode (Profile D). The UICC has a resident capability for supporting one of the above profiles, and so does the terminal. The combination of the capability profile of the UICC and the capability profile of the terminal determines the exact runtime profile of the system.

The terminal also has in its memory software instructions that control proper routing of protocol and parameter data units to the right interface, when the Concurrent mode of operation involves both interfaces. The software instructions also contain embodiment of method used for dynamically making transitioning decisions from one operation mode to another, as well as the mechanism for carrying out such transitioning.

In one embodiment, a terminal contains a communication processor and an application processor. The communication processor is linked to and controls the ISO 7816 interface of the UICC, while the application processor is linked to and controls the IC-USB interface. When the system operates in the Concurrent mode, all APDU commands are sent to the ISO 7816 interface through the communication processor, which is the same as the today's phone architecture. Meanwhile all other protocol commands (such as those used for mass storage and networking) are sent to the IC-USB interface through the application processor, enabling advanced services to mobile applications without burdening the Communication Processor.

The invention thus enables UICCs to support applications that require large storage and/or high bandwidth through the IC-USB interface with relatively small changes to the hardware and software architectures of existing mobile terminals. The invention is also inter-operable with UICCs and terminals that are compliant with the ETSI TS 102 600 standard. A UICC in accordance with the present invention can be used with a terminal that complies with the ETSI TS 102 600 standard as such terminal is equivalent to a terminal supporting Profile B of the present invention. Conversely, a terminal in accordance with the present invention can be used with a UICC that complies with the ETSI TS 102 600 standard as such UICC is equivalent to a UICC supporting either Profile A or B (depending on the UICC's capability) of the present invention. In summary, the invention effectively supports applications, UICCs and terminals that are in compliance to the ETSI TS 102 600 standard with considerably smaller development overhead while ensuring interoperability with ETSI TS 102 600.

In a further embodiment, to reduce design changes and lower manufacturing cost by reusing an existing phone's design, a USB bridge chip is used to connect the IC-USB interface of UICC with the existing USB gadget port on the application processor.

In another embodiment, operation mode transitioning decisions are made such that: when under ISO mode, the device transitions to Concurrent mode when other data interfaces or channels (such as GPRS or Wifi) are activated; and when under Concurrent mode, the device transitions to ISO mode when other data interfaces are deactivated. APDU command extensions are used for initiating mode transitioning related protocol data to the UICC, making it compatible with existing UICC cards and terminals, as well as avoiding conflicts with future ETSI TS 102 600 compliant UICC cards and terminals.

### BRIEF DESCRIPTION OF THE DRAWINGS

FIG. 1 shows the components of a system in accordance with an embodiment of the present invention.

FIG. 2 shows the resultant operation profile when a UICC is inter-operating with a mobile terminal in accordance with an embodiment of the present invention.

FIG. 3 shows a flow chart of a mobile terminal process in accordance with an embodiment of the present invention.

FIG. 4 shows the mode transition diagram for system with runtime profile of Profile A in accordance with an embodiment of the present invention and in compliance with the ISO 7816 standard.

FIG. 5 shows operation mode transitioning diagram of a system with runtime profile of Profile B in accordance with an embodiment of the present invention and in compliance with the ETSI TS 102 600 standard.

FIG. 6 shows the mode transition diagram for system with Profile C in accordance with an embodiment of the present invention.

FIG. 7 shows the mode transition diagram for system with Profile D in accordance with an embodiment of the present invention.

FIG. 8 shows concurrent activation of ISO 7816 and IC-USB interfaces on terminal with a communication processor and an application processor in accordance with an embodiment of the present invention.

FIG. 9 shows connecting a USB interface with application processor in accordance with an embodiment of the present invention.

### DESCRIPTION OF PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

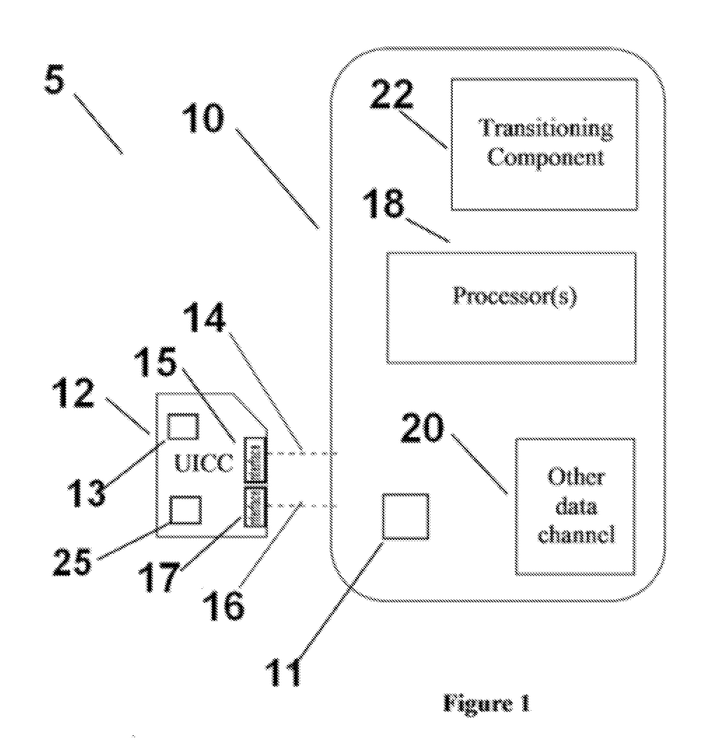

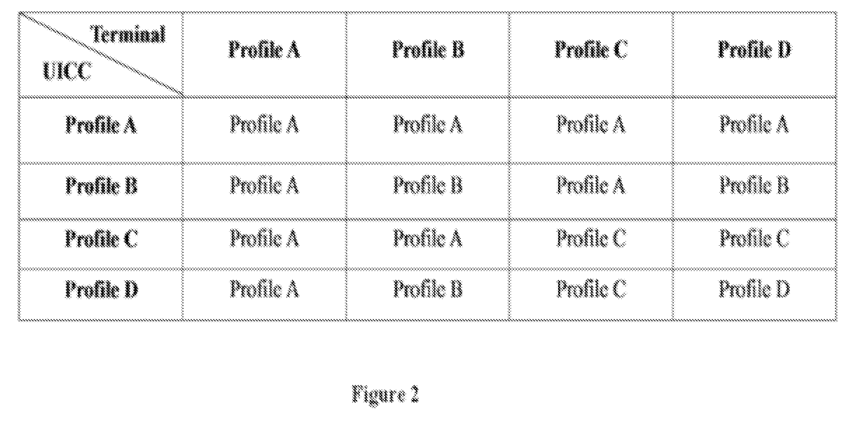

FIG. 1 describes a system 5 in accordance with one embodiment of the present invention. The system 5 includes a terminal 10 and a UICC 12. The UICC 12 has an ISO 7816 interface 15 with corresponding channel 14 that connects to the terminal 10 and an optional IC-USB 17 interface with corresponding channel 16 that connects to the terminal 10. The computer system 5 includes a first interface 15 and second interface 17, computer memories 11, 13 for storing one or more profiles to be discussed below in connection with FIG. 2 for supporting one or more operational communication modes between the terminal 10 and the UICC 12 and further includes one or more processors 18, 25 for executing a USB mode process, ISO mode process and a Concurrent mode process as discussed below.

The terminal 10 has one or more processors 18, one or more other data channels 20 such as WIFI or general packet radio service (GPRS) interface and a Transitioning Component 22. GPRS a packet oriented mobile data service available to users of the 2G cellular communication systems global system for mobile communications (GSM), as well as in the 3G systems. An InterChip USB (IC-USB) specification is an addendum to the USB Forum USB 2.0 specification. IC-USB is intended as a low power variant of the standard physical USB interface, and is made possible by intending its use for direct chip to chip communications. The Transitioning Component 22 is a combination of software, firmware and hardware that embodies mechanisms and methods for determining whether to switch from one operation mode to another, and to actually carry out such switching.

One embodiment of the system 5 operates computer processes 6a, 6b, collectively referred to as process 6, that supports one or more of the following three (3) operating modes: the ISO mode as defined by the ISO 7816 standard, the IC-USB mode as defined by the TS 102 600 standard, and the new Concurrent mode. During the Concurrent mode, both the ISO 7816 interface 15 and the IC-USB interface 17 are activated and used. The set of operation modes and the transitioning mechanism among these modes defines the runtime profile of an embodiment of the system 6. Such runtime profile is determined by the capability profiles of the terminal and the UICC.

Specifically, a UICC 12 memory and a terminal 10 memory store the combinations of a capability profile of the smart card and a capability profile of the terminal for determining the runtime profile of the process. Each capability profile allows the selection of one of ISO mode in compliance with the ISO 7816 standard; IC-USB mode in compliance with the ETSI TS 102 600 standard; and Concurrent mode operation that allows simultaneous use of ISO and IC-USB interfaces. The UICC 12 and the terminal 10 may not support all of the three modes. Rather, a UICC or a terminal may support one of the four profiles, with each profile supporting one or more operation modes. These four profiles are: Profile A that supports only the ISO mode 34; Profile B that supports both ISO mode 34 and IC-USB mode 36; Profile C that supports ISO mode 34 and Concurrent mode 38; and Profile D that supports all three operation modes: ISO mode 34, IC-USB mode 36 and Concurrent mode 38. FIG. 2 lists resulting run-time profiles of the system 5 when UICCs of different profiles are used with terminals of different profiles.

The profile of a system 5 (See, FIG. 1) is selected based upon the inherent capabilities of the terminal 10 and the UICC 12. The capability profile of the terminal 10 and the capability profile of the UICC 12 are a function of the runtime profile of the system 5. Therefore, if the profile of the terminal 10 is known and the profile of the UICC 12 is known then runtime profile of the system 5 can be determined. The terminal 10 includes its capability profile and therefore can determine whether the UICC 12 supports ISO mode 34 and/or IC-USB mode 36 at system 5 initiation phase (this is in accordance with the ETSI standard). Terminal 10 can determine whether the UICC 12 supports Concurrent mode 38. From that point on, the terminal 10 stores the profile of the system 5.

The UICC 12 and the terminal 10 operating within system 5 under the control of process 6 in accordance with one embodiment of the current invention may have the same profile, or they may have different profiles. Specifically: (a) If run-time profile A is the resulting profile, the system 5 works exactly the same as today's handheld phone and SIM card based on ISO 7816 standard. If run-time profile B is the resulting profile, the system works exactly as what ETSI TS 102 600 standard specifies. System 5 can boot up connecting UICC 12 and terminal 10 through either (1) a ISO UART communicating through interface 15 and channel 14 or (2) a IC-USB interface 17 and channel 16. A Universal Asynchronous Receiver/Transmitter (UART) controller is the key component of the serial communications subsystem of a system such as system 5. With an ISO UART connection the system 5 can optionally transit to the IC-USB connection and through a PPS command exchange as described in International Standard ISO IEC 7816-3—Part 3: Electronic signals and transmission protocols, p. 15, Section 7.4. (b)

If run-time profile C is the resulting profile, the system 5 will boot up with ISO connection through interface 15 and channel 14, at first. Through a run-time command sent over the ISO channel 14, the system 5 will enter Concurrent mode 38, and similarly exit the Concurrent mode and returns to ISO mode 34. (c) If run-time profile D is the resulting profile, the system 5 may enter any of the possible operational modes. Terminal 10 will dictate the operation mode and transitioning.

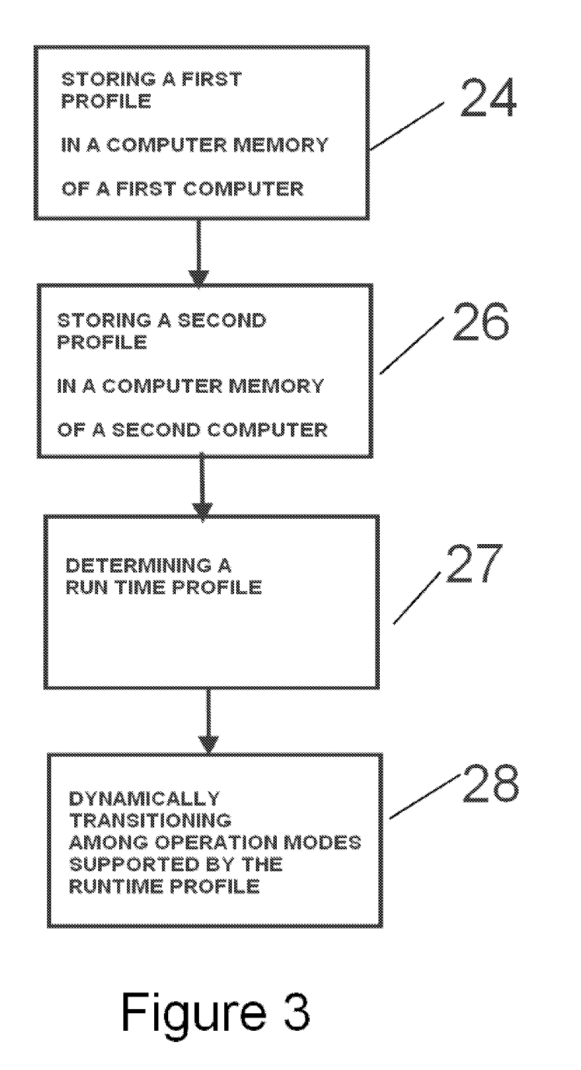

FIGS. 3, 4, 5, 6 and 7 to follow describe embodiments of the invention that include a computer process for dynamically transitioning among operation modes supported by a runtime profile. Turning to FIG. 3, an embodiment of the invention includes, storing a first profile in a computer memory of a first computer 24 to support one or more operational modes, storing a second profile in a computer memory of a second computer 26 to support one or more operational modes, and determining 27, based on a combination of the first profile and the second profile, a runtime profile of the process that results from connecting the first computer with the second computer using one or more interfaces, and dynamically transitioning 28 among operation modes supported by the runtime profile.

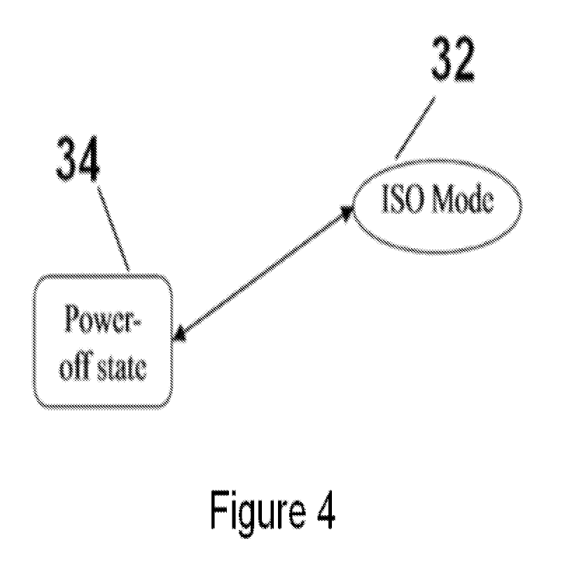

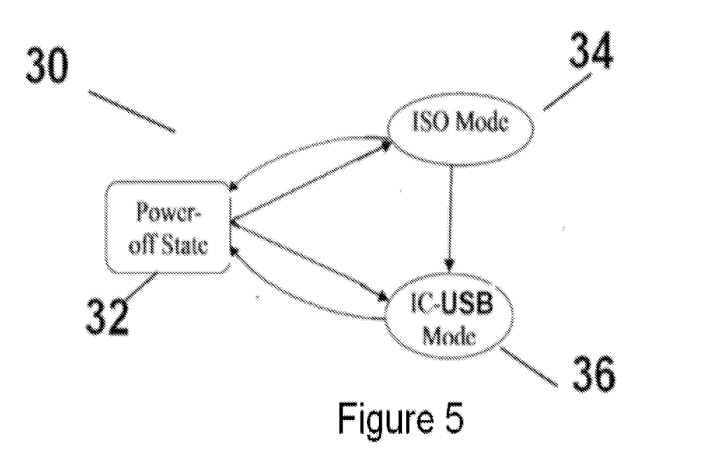

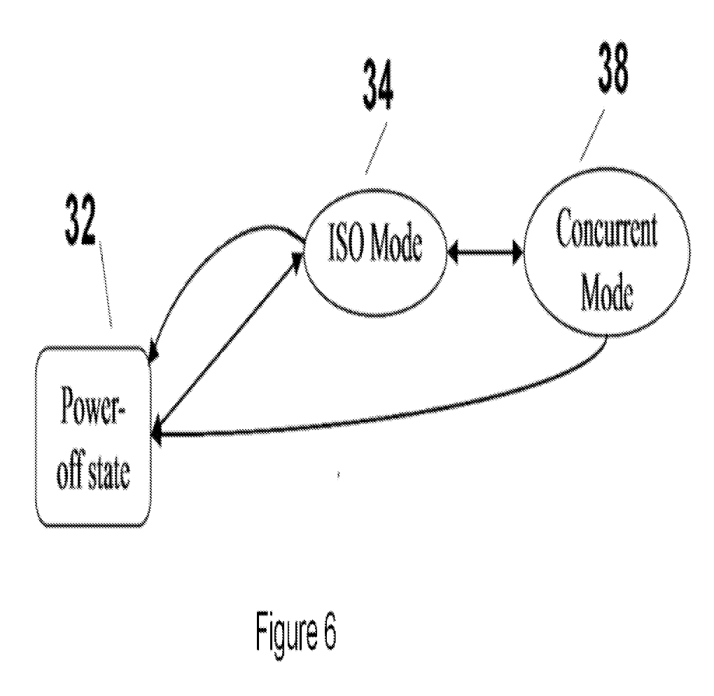

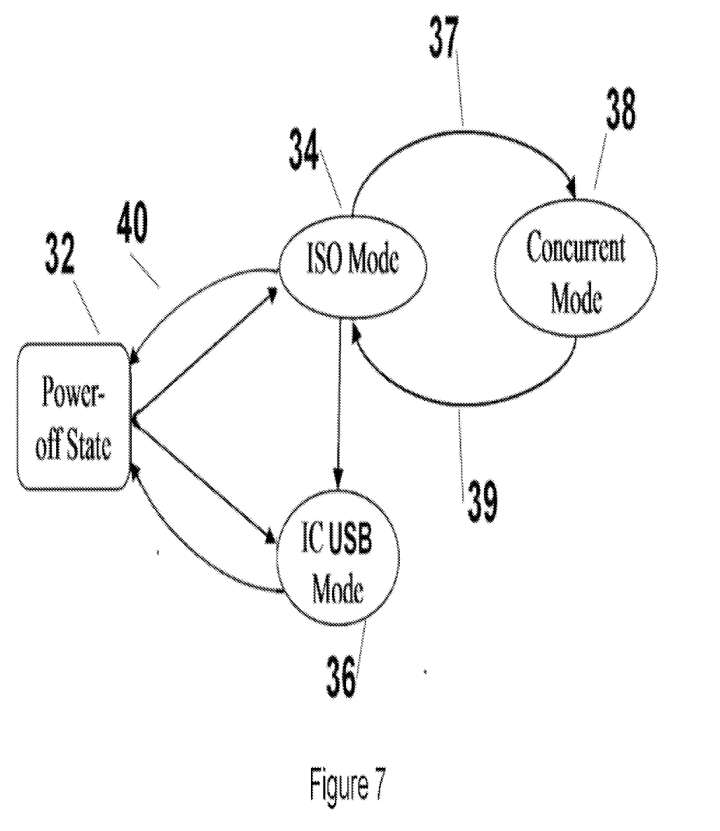

FIG. 4 shows one embodiment of the inventive process utilizing system 5 under the control of process 6 in accordance with the state transition diagram corresponding to FIG. 2, Profile A. FIG. 5 shows one embodiment of the inventive process utilizing system 5 in accordance with the state transition diagram corresponding to the Profile B. FIG. 6 shows one embodiment of the inventive process utilizing system 5 in accordance with the state transition diagram corresponding to the Profile C. FIG. 7 shows one embodiment of the inventive process utilizing system 5 in accordance with the state transition diagram corresponding to the Profile D.

FIG. 5 shows a state transitioning diagram 30 that may be utilized in system 5 under the control of process 6 as defined by the current ETSI TS 102 600 standard. The state transitioning starts in the Power-off State 32, and transitions to either the ISO mode 34 or the IC-USB mode 36 depending on the negotiation between the UICC 12 (see, FIG. 1) and the terminal 10 (see, FIG. 1) in the initiation procedure when the UICC 12 is attached to the terminal 10. Once in the ISO mode 34, transitioning can go back to the Power-off State 32 when either the UICC 12 is detached from the terminal 10 or when the system 5 (see, FIG. 1) is powered off. The ISO mode 34 can also transition to the IC-USB mode 36 when requested. Once transitioned to IC-USB mode 36, either from Power-off State 32 or ISO mode 34, the state can only transition to the Power-off State 32 when, again, either the UICC 12 is detached from the terminal 10 or when the system 5 powers off. Note that once the system is in IC-USB mode 36, there is no transitioning to the ISO mode because functionality-wise, IC-USB mode 36 can provide all the functionalities provided by ISO mode 34.

FIG. 7 shows a state transitioning diagram 40 as one embodiment of the present invention operating under the control of process 6 and utilized in connection with system 5. Compared with a system defined by the ETSI TS 102 600 standard, the system 5 defined by the present invention has an additional Concurrent mode 38, denoting the operational mode when both the ISO 7816 interface 15 and the IC-USB interface 17 are activated and used. After an initial communication has been established between the terminal 10 and the UICC 12, the terminal 10 will wait for an ATR (Answer to Reset) from the UICC 12. The ATR is used by the UICC 12 to communicate to the terminal 10 its feature set or capabilities. For example, in one non limiting embodiment two special status numbers 0xE0 hexadecimal when the terminal 10 is the USB master and 0xE1 hexadecimal when UICC 12 is the master indicate that the UICC 12 supports Concurrent mode 38 operation.

Still referring to FIG. 7, once the terminal 10 process 6a determines that the UICC 15 supports Concurrent mode 38, it may employ the ISO channel 14 to transmit ISO 7816 commands, while using the USB channel 16 for other protocols. The system under the control of process 6 goes into Concurrent mode 38 when the terminal 10 starts employing both channel 14 and channel 16 simultaneously. The system 5 under the control of process 6 enters Concurrent mode 38 when the terminal 10 sends a special Application Protocol Data Unit (APDU) command to the UICC 12. For example, in one non limiting embodiment, the APDU command E5 70 01 00 00 hexadecimal cause system 5 to enter the Concurrent mode 38.

Still referring to FIG. 7, to exit Concurrent mode 38, the terminal 10 sends another special Application Protocol Data Unit (APDU) command to the UICC 12. For example, in one non limiting embodiment the APDU command E5 70 02 00 00 hexadecimal causes system 5 to exit the Concurrent mode 38. Note that, the system 5 can go into the Concurrent mode when it is currently in ISO mode 34, and that when it exits Concurrent mode 38, it will go back into ISO mode 34.

When in Concurrent mode, both the ISO channel 14 and the USB channel 16 are in use, because ISO 7816 protocol commands now go through the ISO channel 14, while other protocols (e.g., Ethernet Emulation and Mass Storage) go through the USB channel 16. The ISO 7816 protocol is used to store and retrieve information (e.g., about the SIM accounts) stored on a SIM card. The USB related protocols are used to support applications such as Web Server and Streaming server. The Concurrent mode provides the same application support as the IC-USB mode 36. The only difference is that in IC-USB mode 36, everything goes through the USB channel 16, since the ISO channel 14 would be deactivated.

Decisions on transitioning into/out-of Concurrent mode 38 are made by the software process 6a resident in the terminal 10. Such decisions are made based on by way of example and not limitation, power conservation. In one non limiting embodiment, Concurrent mode 38 operation is coupled to data channels such as GPRS. In such embodiment, the system 5 enters Concurrent mode 38 when GPRS is activated, and exits from the Concurrent mode 38 when the GPRS channel is deactivated. FIG. 7 shows one embodiment of triggering mechanism for state transitions between the ISO mode 34 and the Concurrent mode 38 in the state transition diagram of a system as defined by the present invention. In this embodiment, the system 5 activates through transition 37 to the Concurrent mode 38 from the ISO mode 34 when a data channel of the system 5, such as WIFI or GPRS, is activated, and transitions back through transition 39 to the ISO mode 34 from the Concurrent mode 38 when such other data channel is deactivated.

The system 5 under the control of process 6 can transition to Concurrent mode 38 from the ISO mode 34, and can transition back to the ISO mode 34 from the Concurrent mode 38. When the system is in ISO mode 34, the terminal 10 can query whether the UICC supports Concurrent mode 38 by sending the terminal 10 an extended APDU command through the ISO channel 14. The UICC 12 will ignore such extended APDU if it does not support Concurrent mode 38. Essentially this is what occurs if a legacy system is in use.

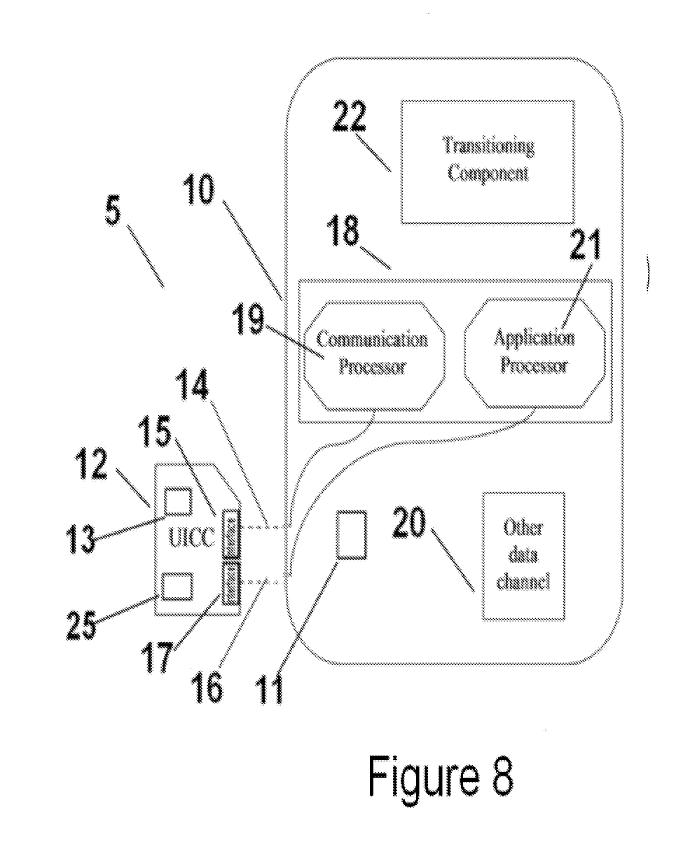

FIG. 8 shows one embodiment of a mobile device in accordance with the present invention that supports the concurrent use of the ISO 7816 interface 15 and the IC-USB 17 interface. The computer system 5 includes: a terminal 10 connected to a smart card 12 through an interface, said interface having first interface 15 and second interface 17, computer memories 11,13 for storing one or more profiles as in FIG. 2 for supporting one or more operational communication modes between the terminal 10 and the smart card 12, said system further includes one or more processors 18, 25 for executing a USB mode process, ISO mode process and a Concurrent mode process, wherein based upon a selected profile stored in memories 11,13, the processor selectively activates the Concurrent mode process for simultaneously communicating one of data or ISO protocol commands over the first interface and communicating one of data or USB protocols over the second interface, and the processor deactivates the Concurrent mode process and returns to the ISO mode process at the completion of simultaneously communicating.

In the embodiment shown in FIG. 8, the mobile device has at least one communication processor 19 and at least one application processor 21. The ISO 7816 interface 15 of the UICC 12 is connected to a communication processor 19, and the IC-USB interface 17 is connected to an application processor 21. One advantage of this embodiment is that it can be implemented with minor changes to the hardware and software design of existing mobile devices.

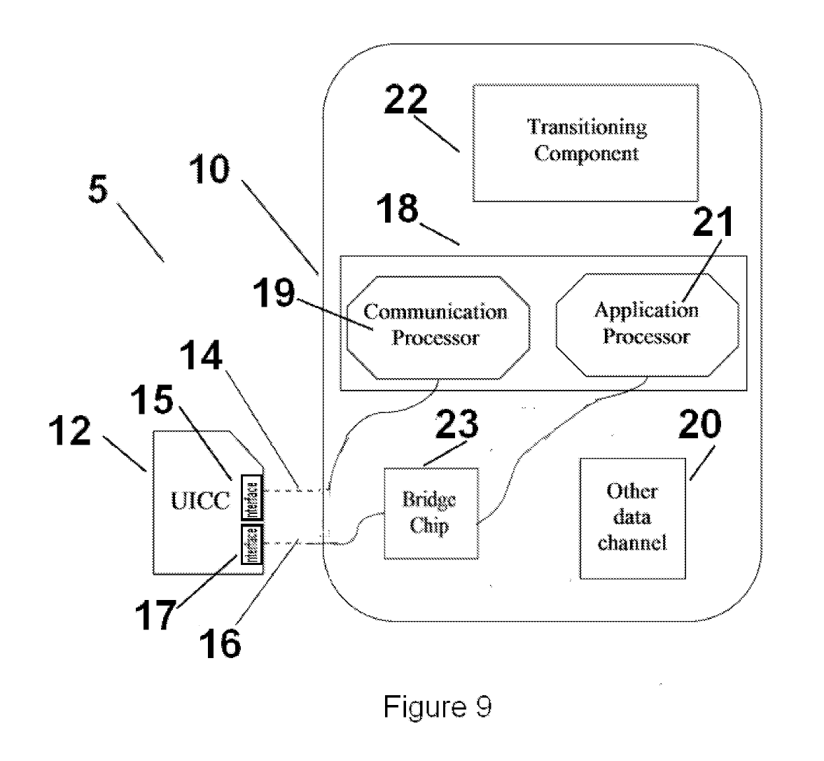

FIG. 9 shows an embodiment of the invention connecting the IC-USB interface 17 of the UICC 12 to the application processor 21 of a mobile device. In this embodiment, a USB bridge chip 23 is used to connect the IC-USB interface 17 with an existing USB port of the main chipset utilized in terminal 10. In one embodiment, the UICC 12 is configured as a USB host and supports an Ethernet Emulation model (EEM) application (see, Universal Serial Bus Communications Class Subclass Specification for Ethernet Emulation model Devices 2005 USB Implementers Forum, Inc). In another embodiment, the UICC 12 is configured as a USB gadget and supports a USB Mass Storage (UMS) application, in addition to the EEM application (see, Universal Serial Bus Mass Storage Class Specification Overview, Release 1.1).

While the foregoing invention has been described with reference to the above embodiments, additional modifications and changes can be made without departing from the spirit of the invention. Accordingly, such modifications and changes are considered to be within the scope of the appended claims.

We claim:

1. A computer process comprising: storing a first profile in a computer memory of a first computer to support one or more operational modes, storing a second profile in a computer memory of a second computer to support one or more operational modes, and determining, based on a combination of the first profile and the second profile a runtime profile of the process that results from connecting the first computer with the second computer using one or more interfaces, and dynamically transitioning among operation modes supported by the runtime profile.

2. The computer process of claim 1 further including embedding part of the computer process into the first computer and embedding part of the computer process into the second computer.

3. The computer process of claim 1 wherein the first computer is a smart card device.

4. The computer process of claim 3 wherein the smart card device is a UICC device.

5. The computer process of claim 1 wherein the second computer is a mobile terminal.

6. The computer process of claim 5 wherein the said mobile terminal has a communication processor and an application processor.

7. A computer process of claim 1 wherein:
a. the said interfaces include at least one or more of an ISO 7816 compatible interface and an ETSI TS 102 600 compatible IC-USB interface,
b. the said operational modes include at least one or more of an ISO mode compatible to the ISO 7816 standards, an IC-USB mode compatible to the ETSI TS 102 600 standards, and a Concurrent mode for simultaneously communicating one of data or ISO protocol commands over an ISO 7816 compatible interface and communicating one of data or IC-USB protocol commands over an ETSI TS 102 600 compatible IC-USB interface, and
c. the said profiles include at least one or more of a profile A for supporting ISO mode of operation, a profile B for supporting ISO and IC-USB modes of operation, a profile C for supporting ISO and Concurrent modes of operation, and a profile D for supporting ISO, IC-USB and Concurrent modes of operation.

8. The computer process of claim 7 wherein determining the said runtime profile depends on the first profile and the second profile to look up a third profile.

9. The computer process of claim 7 wherein when one of the supported modes of operation of the said runtime profile is the Concurrent mode of operation, transitioning among operation modes include transitioning to the Concurrent mode from the ISO mode, and transitioning back to the ISO mode from the Concurrent mode.

10. The computer process of claim 9 wherein the transitioning to the Concurrent mode from the ISO mode includes sending transitioning command compatible with the ISO 7816 standard through the ISO 7816 compatible interface.

11. The computer process of claim 9 wherein the transitioning to the ISO mode from the Concurrent mode includes one of (a) either sending transitioning command compatible with the ISO 7816 standard through the ISO 7816 compatible interface or (b) sending transitioning command compatible with the ETSI TS 102 600 standard through the IC-USB interface.

12. The computer process of claim 7 wherein the said ISO interface is connected to a communication processor of the said second computer, and the said IC-USB interface is connected to an application processor of the said second computer.

13. Computer software embodied on a computer readable medium comprising: code for supporting a first profiles on a smart card device, code for supporting a second profile on a terminal, code for supporting each of the one or more of the operation modes of each of the one or more of the profiles, code for transitioning among one or more of the operation modes of each of the one or more profiles, and code for determining a runtime profile when the smart card device is connected to the terminal using one or more interfaces.

14. The computer software of claim 13 wherein at least part of the code is stored in a smart card device and part of the code is stored in a terminal.

15. The computer software of claim 14 wherein the smart card device is a UICC.

16. The computer software of claim 14 wherein the terminal is a mobile terminal.

17. The computer software of claim 13 wherein
a. the said interfaces include at least one or more of an ISO 7816 compatible interface and an ETSI TS 102 600 compatible IC-USB interface,
b. the said operational modes includes an ISO mode compatible to the ISO 7816 standards, an IC-USB mode compatible to the ETSI TS 102 600 standards, and a Concurrent mode for simultaneously communicating one of data or ISO protocol commands over an ISO 7816 compatible interface and communicating one of data or IC-USB protocol commands over an ETSI TS 102 600 compatible IC-USB interface, and
c. the said profiles include a profile A for supporting ISO mode of operation, a profile B for supporting ISO and IC-USB modes of operation, a profile C for supporting ISO and Concurrent modes of operation, and a profile D for supporting ISO, IC-USB and Concurrent modes of operation.

18. The computer software of claim 17 wherein the code for determining the runtime profile is through using the first profile and the second profile to look up a third profile.

19. The computer software of claim 17 wherein when one of the supported modes of operation of the said runtime profile is the Concurrent mode of operation, the code for transitioning among operation modes includes code for transitioning to the Concurrent mode from the ISO mode, and code for transitioning back to the ISO mode from the Concurrent mode.

20. The computer software of claim 17 wherein the code for transitioning to the Concurrent mode from the ISO mode uses the activation of other data channels as input, and the code for transitioning to the ISO mode from the Concurrent mode uses the deactivation of other data channels as input.

21. A computer system comprising: a smart card connected to a terminal through one or more interfaces, a computer memory within the smart card for storing a first profile for supporting one or more operational modes, a computer memory within the terminal for storing a second profile for supporting one or more operational modes, wherein said first profile and said second profile associatively determine the system's runtime profile for supporting one or more operational modes, and the system dynamically transitions among operational modes supported by the runtime profile.

22. The computer system of claim 21 wherein
a. the said interfaces include at least one or more of an ISO 7816 compatible interface and an ETSI TS 102 600 compatible IC-USB interface, and
b. the said operational modes includes an ISO mode compatible to the ISO 7816 standards, an IC-USB mode compatible to the ETSI TS 102 600 standards, and a Concurrent mode for simultaneously communicating one of data or ISO protocol commands over an ISO 7816 compatible interface and communicating one of data or IC-USB protocol commands over an ETSI TS 102 600 compatible IC-USB interface, and
c. the said profiles include a profile A for supporting ISO mode of operation, a profile B for supporting ISO and IC-USB modes of operation, a profile C for supporting ISO and Concurrent modes of operation, and a profile D for supporting ISO, IC-USB and Concurrent modes of operation.

23. The computer system of claim 22 wherein the smart card is configured as a USB host in Concurrent mode.

24. The computer system of claim 22 wherein the smart card is configured as a USB gadget in Concurrent mode.

25. The computer system of claim 22 wherein the smart card is a UICC card.

26. The computer system of claim 22 wherein the terminal includes at least one communication processor and at least one application processor.

27. The computer system of claim 26 wherein the UICC card is connected through the ISO 7816 interface to the communication processor and connected through the IC-USB interface to application processor.

28. The computer system of claim 26 wherein the IC-USB interface connects through a USB bridge chip to the application processor's USB port.

29. The computer system of claim 22 including at least an Ethernet Emulation Model application software.

30. The computer system of claim 22 further including a USB Mass Storage application software.
